(19) United States
(12) Patent Application Publication
(10) Pub. No.: US 2007/0039939 A1
(43) Pub. Date: Feb. 22, 2007

(54) Cradle for holding an electric iron

(76) Inventor: John Augusto Mariani, Ramsgate Beach, New South Wales (AU)

Correspondence Address: JACOBSON & JOHNSON, ONE WEST WATER STREET, SUITE 285, ST. PAUL, MN, 55107, US

(21) Appl. No.: 10/572,301

(22) PCT Filed: Mar. 29, 2005
(86) PCT No.: PCT/AU05/00447

§ 371 Date: Mar. 14, 2006

(30) Foreign Application Priority Data
Mar. 29, 2004 (AU) 2004901681

(51) Int. Cl. H05B 1/00; H05B 3/00; H05B 11/00

(52) U.S. Cl. 219/217

(57) ABSTRACT

A cradle (10) for holding an electric iron (12) has an upright base plate (14) to which, in use, a sole plate (49) of the electric iron is in facing relationship. It also has a support plate (16) extending outwardly from one side of the lower end of the upright base plate for supporting a heel (51) of the electric iron, and first and second side flanges (18,20) extending outwardly from opposed sides of the upright base plate. The first and second side flanges terminate in respective free edges that are spaced apart from each other to define a side opening. The combination of the upright base plate, support plate, and first and second side flanges define a holding cavity for the electric iron. The first and second side flanges are angled inwardly toward each other to generally correspond to the wedge shape of the electric iron and to prevent removal of the electric iron from the side opening of the cradle. The upright base plate and the first and second side flanges extend upwardly to define a top opening that is at a sufficient height so as to require that the electric iron be lifted from within the cradle by at least its full height to enable its removal from the top opening of the cradle.

### TECHNICAL FIELD

The present invention relates to a cradle for holding an electric iron, as well as to a mounting adaptor for the cradle.

### BACKGROUND OF THE INVENTION

Hot electric irons are often the cause of personal injury or property damage as a result of fire that may occur when they are not properly put away after use or during a pause in use.

A homemaker may leave a hot electric iron unattended while performing other household tasks, such as tending to a crying infant, answering the phone, or stirring the kitchen pot. A small child or pet tugging on the cord to the iron may knock it over, causing the hot iron surface to contact an ignitable surface or to scorch the skin. A small child may also seek to grab the hot iron, an act which would result in painful burns to the hands and fingers.

U.S. Pat. No. 2,514,400 to Larkins discloses an electric iron holder that includes an upright base plate, a support, and retainer flanges at opposed sides of the support for slidably engaging and retaining an iron relative to the support to facilitate its safe positioning when not in use or when heated.

The retainer flanges do not extend the full height of the iron when supported within the holder, and so it may be possible for a small child to place their fingers upon the hot iron surface from the sides of the holder.

U.S. Pat. No. 2,486,448 to Traxler discloses an electric iron holder that includes an upright base portion, a stop, and opposed side flanges for slidably engaging and retaining an iron that is so disposed on the holder that its point is lowermost. The side flanges do not extend the full height of the iron when supported in the holder, thereby making the hot iron prone to being touched by a small child from the sides of the holder, and from beneath the holder as the point of the iron is exposed. Also a small child may be able to grip the handle of the iron whilst in the holder and easily lift it free, because of the relatively short height of the side flanges in comparison to the height of the iron whilst in the holder.

U.S. Pat. No. 2,311,974 to Smith and U.S. Pat. No. 2,529,132 to Burnish et al disclose electric iron holders that also may suffer the aforementioned problems arising from the relatively short height of their flange members compared to the iron.

### OBJECT OF THE INVENTION

It is an object of the present invention to provide a cradle for holding an electric iron after use or during a pause in use, when the iron is still hot, that gives the user peace of mind in knowing that the hot iron surface is safely concealed from, or inaccessible to, the hands of a small child or an ignitable surface.

It is another object of the invention to provide an electric iron cradle that requires lifting of the iron from its support over approximately its full height before it is free of the cradle, thereby rendering the task of removing the iron from the cradle more difficult for a small child than is the case with the aforementioned prior art.

It is yet another object of the invention to provide a support assembly for an electric iron comprising an electric iron cradle and a mounting adaptor therefor.

### SUMMARY OF THE INVENTION

According to the invention there is provided a cradle for holding an electric iron comprising an upright base plate to which, in use, a sole plate of the electric iron is in facing relationship, a support plate extending outwardly from one side of the lower end of the upright base plate for supporting a heel of the electric iron, first and second side flanges extending outwardly from opposed sides of the upright base plate and terminating in respective free edges that are spaced apart from each other to define a side opening, the combination of the upright base plate, support plate, and first and second side flanges defining a holding cavity for the electric iron, the first and second side flanges being angled inwardly toward each other to generally correspond to the wedge shape of the electric iron and to prevent removal of the electric iron from the side opening of the cradle, wherein the upright base plate and the first and second side flanges extend upwardly to define a top opening that is at a sufficient height so as to require that the electric iron be lifted from within the cradle by at least its full height to enable its removal from the top opening of the cradle.

Preferably, the cradle includes a rack integrally joined to one of the side flanges for looping a cord of the iron thereabout.

It is preferred that the first and second side flanges are flared outwardly at respective upper ends thereof so that the top opening is wider than the support plate.

In a preferred form, the respective free edges of the first and second side flanges diverge in a direction from the support plate to the top opening, whereby the side opening is wider at its top end than at its bottom end.

The upright base plate preferably includes a planar wall portion and ribbed portions that project into the holding cavity to separate the sole plate of the electric iron from the planar wall portion.

According to another aspect of the invention, there is provided a support assembly for an electric iron comprising the abovementioned electric iron cradle and a mounting adaptor therefor.

Preferably, the mounting adaptor includes a base portion and an upwardly stepped portion, the upwardly stepped portion being adapted to engage to a hollow skirted portion at the underside of the support plate of the cradle.

It is preferred that the upwardly stepped portion includes slots formed through side walls thereof, and the hollow skirted portion includes teeth that are adapted to engage respective slots for mounting the cradle to the mounting adaptor.

In a preferred form, the hollow skirted portion is wider than the upwardly stepped portion for locating the skirted portion over the stepped portion, the cradle being adapted to slide over the mounting adaptor in a direction so as to cause the teeth to engage the slots.

The mounting adaptor preferably includes catch means for abutting against a wall of the hollow skirted portion when the teeth engage the slots so as to prevent the cradle sliding over the mounting adaptor in a direction that would allow the teeth to disengage the slots.

Preferably, the mounting adaptor includes a press panel, and the catch means projects upwardly therefrom, the press panel being adapted to flexibly pivot downwardly upon application of downward pressure thereon, whereby the catch means no longer abuts against the wall of the skirted portion and the cradle can slide over the mounting adaptor in a direction that would allow the teeth to disengage the slots.

### BRIEF DESCRIPTION OF THE DRAWINGS

FIG. 1 is a front elevational view of a preferred electric iron cradle of the invention.

FIG. 2 is a front elevational view of a preferred mounting adaptor for engaging the electric iron cradle of FIG. 1.

FIG. 3 is a side elevational view of the electric iron cradle shown in FIG. 1.

FIG. 4 is a side elevational view of the mounting adaptor shown in FIG. 2.

FIG. 5 is a top perspective view of a preferred electric iron support assembly of the invention showing the electric iron cradle of FIG. 1 disengaged from the mounting adaptor of FIG. 2.

FIG. 6 is a bottom perspective view of the electric iron support assembly shown in FIG. 5.

FIG. 7 is a plan view of the cradle shown in FIG. 1 engaged to the mounting adaptor shown in FIG. 2.

FIG. 8 is a front elevational view of the electric iron support assembly shown in FIG. 7 supporting an electric iron.

FIG. 9 is a top elevational view of the electric iron support assembly with supported electric iron shown in FIG. 8.

FIG. 10 is a right side perspective view of the electric iron support assembly with supported electric iron shown in FIGS. 8 and 9.

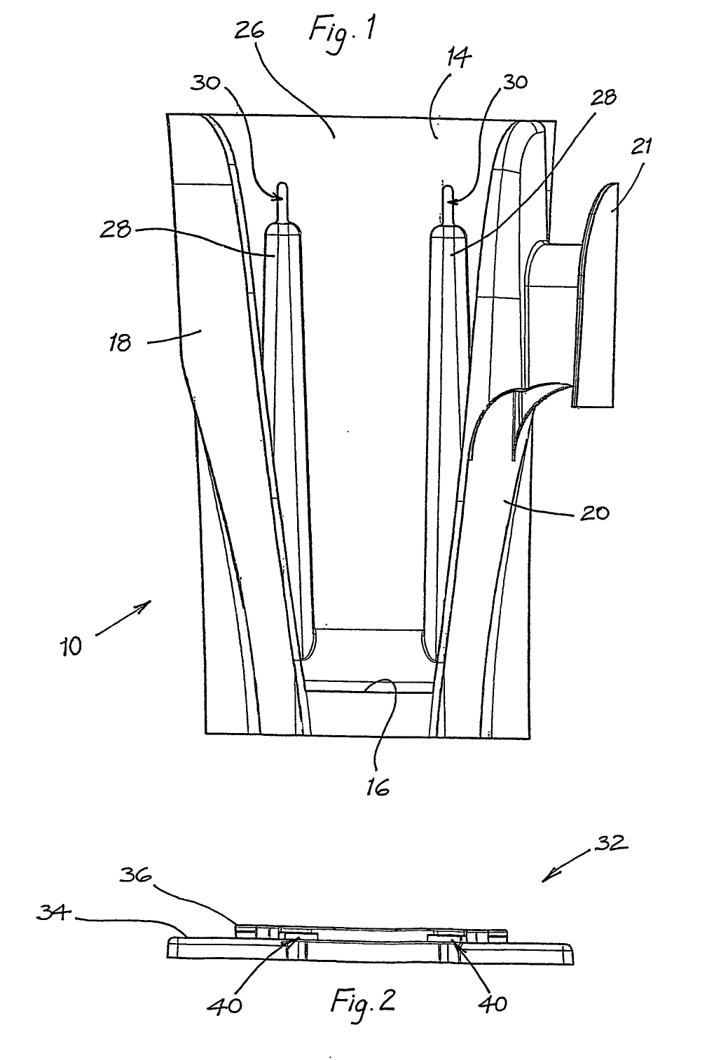

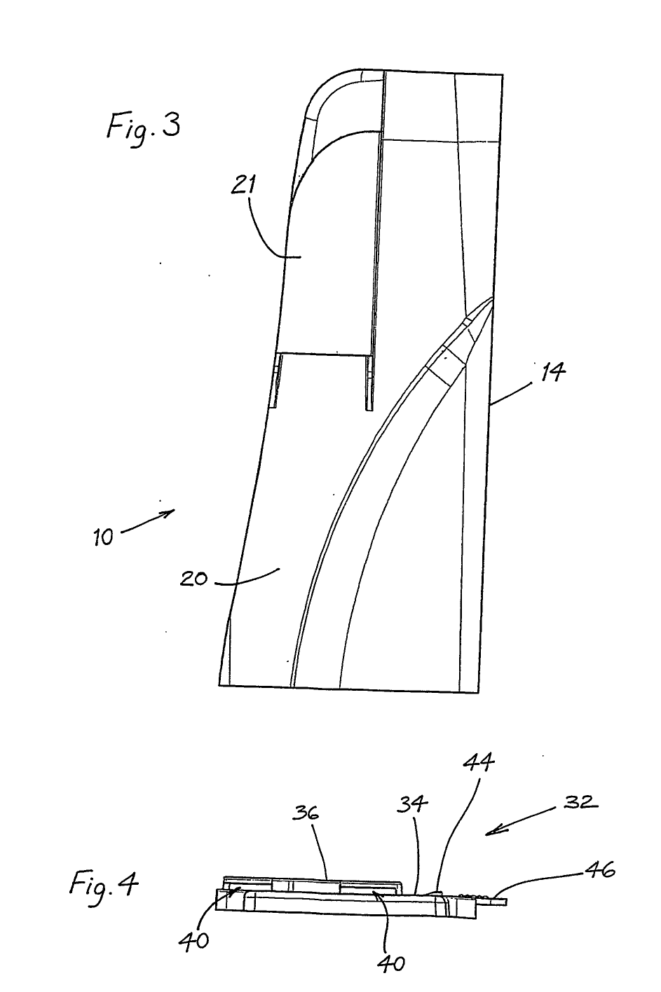

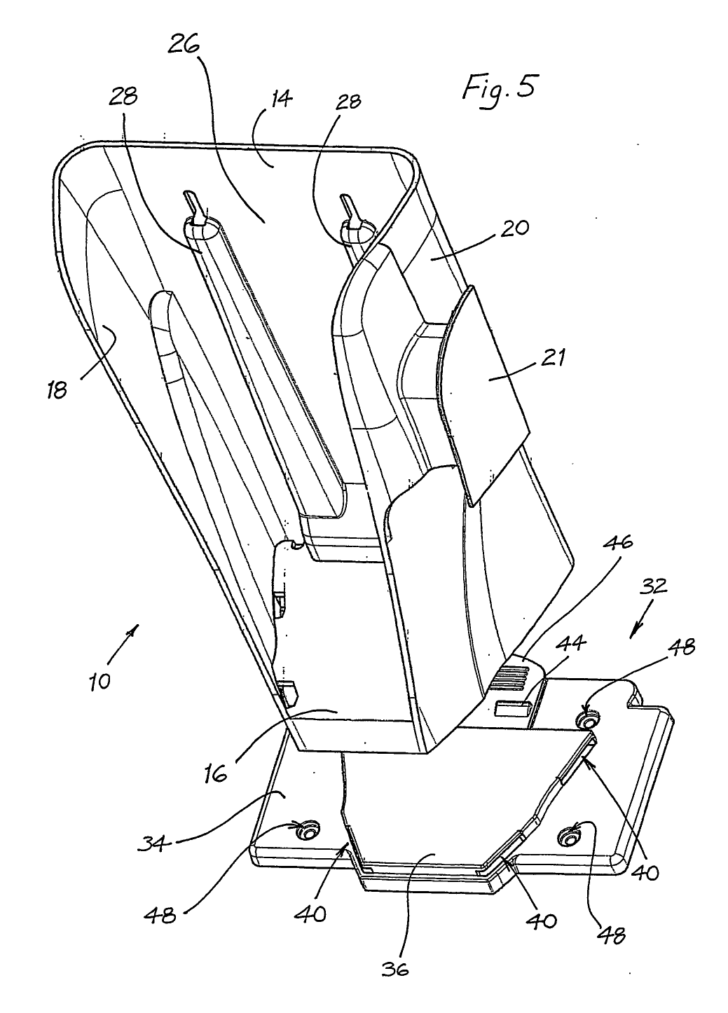

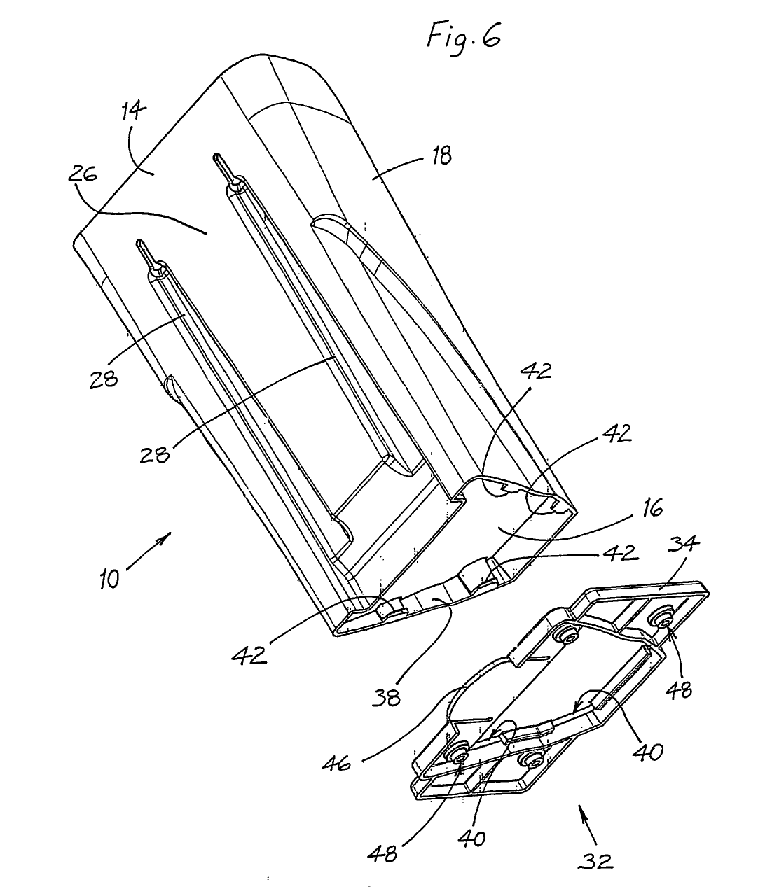

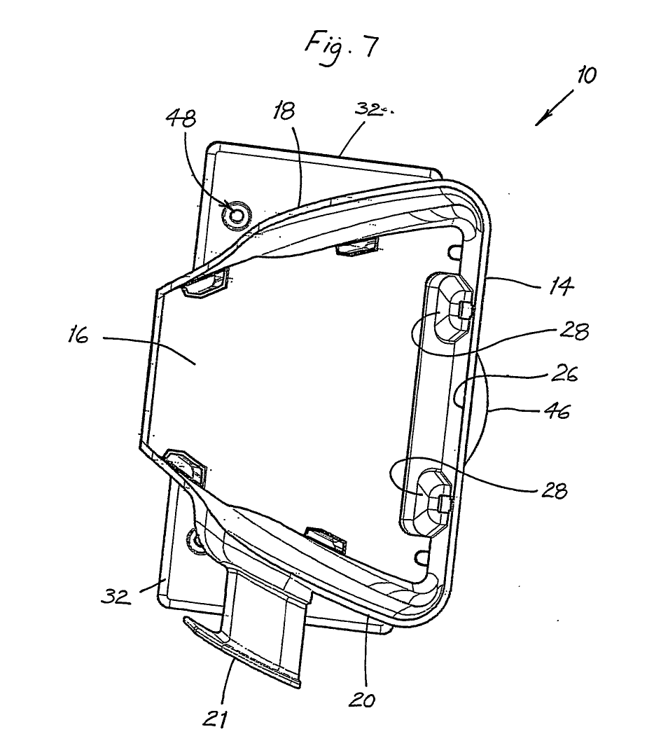

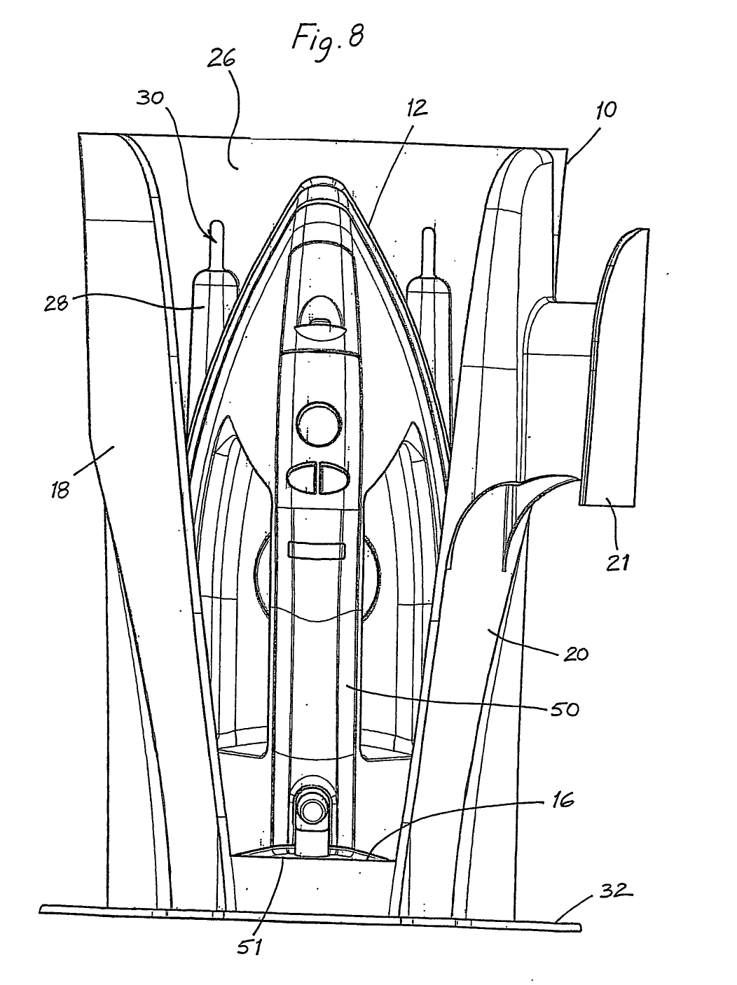

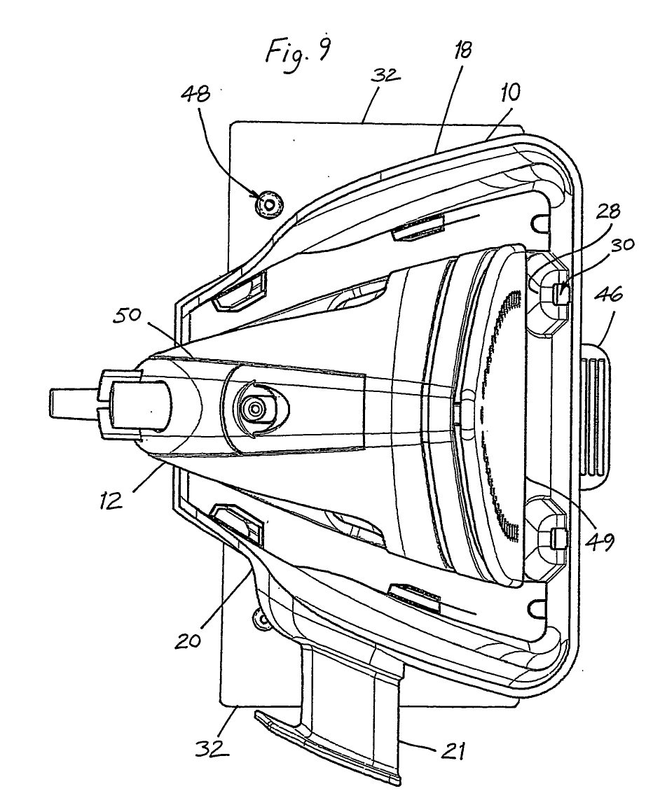

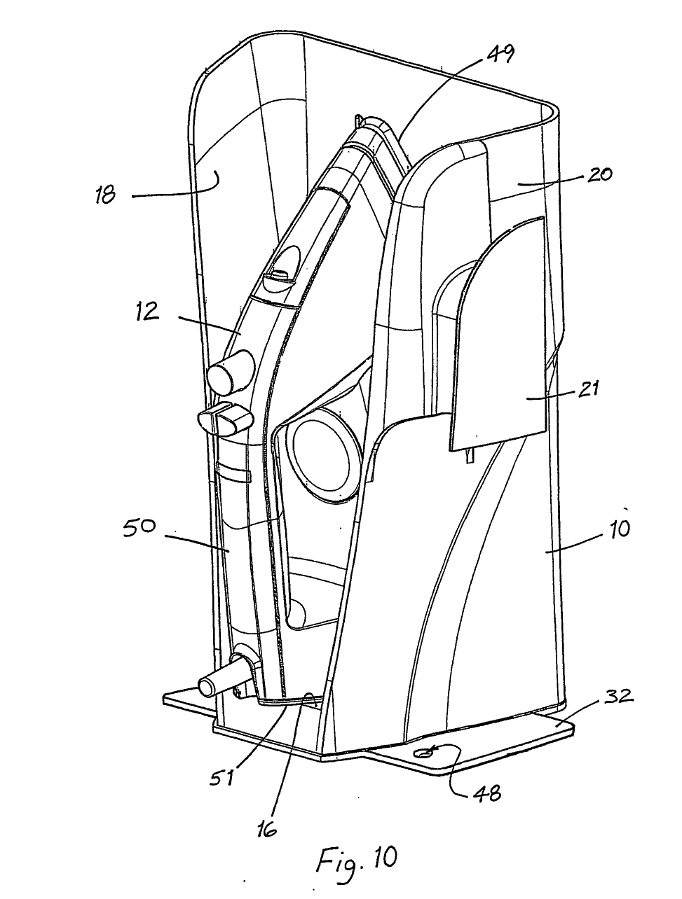

### DETAILED DESCRIPTION OF THE PREFERRED EMBODIMENT

The electric iron cradle 10 shown in the Figures is injection moulded in one piece of a glass fibre reinforced thermosetting material based on unsaturated polyester resin. The cradle 10 has a height which is slightly greater than that of an electric iron 12 which is cradled or held therein. The cradle 10 has an upright base plate 14, a support plate 16 extending outwardly from one side of the lower end of the upright base plate 14, and first and second side flanges 18,20 extending outwardly from opposed sides of the upright base plate 14. The first and second side flanges 18,20 terminate in respective free edges that are spaced apart from each other to define a side opening. The upright base plate and the first and second side flanges extend upwardly to define a top opening. The first and second side flanges are angled inwardly toward each other to generally correspond to the wedge shape of the electric iron and to prevent removal of the electric iron from the side opening of the cradle. The combination of upright base plate, support plate, and first and second side flanges define a holding cavity for an electric iron. The top opening is at a sufficient height so as to require that the electric iron be lifted from within the cradle by at least its full height to enable its removal from the top opening of the cradle.

A rack 21 is integrally joined to one of the side flanges 20 for looping the cord of the iron thereabout.

Each side flange 18,20 is flared outwardly at respective upper ends thereof so that the top opening is wider than the support plate 16. The respective free edges of the first and second side flanges diverge in a direction from the support plate to the top opening so that the side opening is wider at its top end than at its bottom end.

The upright base plate 14 includes a planar wall portion 26 and ribbed portions 28 that project into the holding cavity to separate the sole plate of the electric iron from the surface of the planar wall portion.

The overall height of the cradle 10 is slightly greater than the height of the iron 12 when held therein so that the hot iron surface or sole plate is safely concealed from, or inaccessible to, the hands of a small child or an ignitable surface.

Apertures 30 for receiving hanging hooks, screws or the like are formed through the upright base plate 14 to enable the cradle 10 to be temporarily or permanently secured to, say, a wall or door near an ironing table. The cradle 10 may alternatively be attached to the iron table itself, or may be left unattached to anything and left free standing in a storage location, such as a cupboard. Similar apertures may be formed through the support plate 16 where it is desired to permanently secure the cradle 10 to, say, a table or shelf surface. However, the cradle 10 is suited to being mounted removably to a mounting adaptor to create a support assembly for the electric iron.

The mounting adaptor 32 is made of a similar material to that of the cradle 10 and includes a base portion 34 and an upwardly stepped portion 36. The stepped portion is adapted to engage to a hollow skirted portion 38 at the underside of the support plate of the cradle.

The upwardly stepped portion includes slots 40 formed through side walls thereof, and the hollow skirted portion includes teeth 42 that are adapted to engage respective slots for mounting the cradle to the mounting adaptor.

The hollow skirted portion 38 is wider than the upwardly stepped portion 36 so that the skirted portion can locate over the stepped portion. When so located, the cradle is able to be slid over the mounting adaptor in a direction that enables the teeth to engage the slots.

The mounting adaptor also has catch means, in the preferred form of ramp like projections 44, that abut against a wall of the hollow skirted portion when the teeth engage the slots. In this way, the cradle is prevented from sliding over the mounting adaptor in a direction that will cause the teeth to disengage the slots.

There is a press panel 46 incorporated in the mounting adaptor, and the ramp like projections 44 project upwardly therefrom. The press panel 46 is adapted to flexibly pivot downwardly upon application of downward pressure thereon. Upon such movement, the ramp like projections no longer abut against the wall of the skirted portion and the cradle is free to slide over the mounting adaptor in a direction that causes the teeth to disengage the slots and allows the cradle to be detached from the mounting adaptor.

Apertures 48 for receiving screws or the like are formed through the base portion 34 of the mounting adaptor 32 to enable the mounting adaptor to be secured to a horizontal surface, say, near an ironing table. The mounting adaptor may, alternatively, be unsecured to any surface but be removably supported, say, to the ironing table itself or to a stand connected to one side of the ironing table.

In use, the electric iron 12 is held in the cradle 10 after being inserted, heel first, from above the cradle 10 through the top opening defined by the upper edges of the upright base plate 14 and side flanges 18,20, and then being supported on the support plate 16, such that the sole plate 49 of the iron 12 is in facing relationship to the upright base plate 14 and the heel 51 of the iron 12 is supported on the base plate 16.

The first and second flanges 18,20 are so angled inwardly toward each other that they prevent sideways removal of the iron 12 from the cradle 10, whether that may otherwise occur as a result of a small child grabbing the iron's handle and trying to pull it away from the cradle, or of the cradled iron being knocked over.

The only way in which the iron 12 may be ordinarily removed from within the cradle 10 is by gripping the iron's handle 50 that protrudes through the side opening between the side flanges 18,20 and lifting the iron 12 upwardly to just over its full height before it is free of the cradle 10, thereby rendering the task of removing the iron 12 from the cradle 10 difficult for a small child.

Once the iron 12 is held within the cradle 10, a cord of the iron may be looped or wound about the rack 21 in the manner of a storage reel.

It will be readily apparent to persons skilled in the art that various modifications may be made in details of design and construction of the electric iron cradle and its mounting adaptor without departing from the scope or ambit of the invention.

1. A cradle for holding an electric iron comprising an upright base plate to which, in use, a sole plate of the electric iron is in facing relationship, a support plate extending outwardly from one side of the lower end of the upright base plate for supporting a heel of the electric iron, first and second side flanges extending outwardly from opposed sides of the upright base plate and terminating in respective free edges that are spaced apart from each other to define a side opening, the combination of the upright base plate, support plate, and first and second side flanges defining a holding cavity for the electric iron, the first and second side flanges being angled inwardly toward each other to generally correspond to the wedge shape of the electric iron and to prevent removal of the electric iron from the side opening of the cradle, wherein the upright base plate and the first and second side flanges extend upwardly to define a top opening that is at a sufficient height so as to require that the electric iron be lifted from within the cradle by at least its full height to enable its removal from the top opening of the cradle.

2. The cradle of claim 1 and including a rack integrally joined to one of the side flanges for looping a cord of the iron thereabout.

3. The cradle of claim 1 wherein the first and second side flanges are flared outwardly at respective upper ends thereof so that the top opening is wider than the support plate.

4. The cradle of claim 1 wherein the respective free edges of the first and second side flanges diverge in a direction from the support plate to the top opening, whereby the side opening is wider at its top end than at its bottom end.

5. The cradle of claim 1 wherein the upright base plate includes a planar wall portion and ribbed portions that project into the holding cavity to separate the sole plate of the electric iron from the planar wall portion.

6. A support assembly for an electric iron comprising the cradle of claim 1 and a mounting adaptor therefor.

7. The support assembly of claim 6 wherein the mounting adaptor includes a base portion and an upwardly stepped portion, the upwardly stepped portion being adapted to engage to a hollow skirted portion at the underside of the support plate of the cradle.

8. The support assembly of claim 7 wherein the upwardly stepped portion includes slots formed through side walls thereof, and the hollow skirted portion includes teeth that are adapted to engage respective slots for mounting the cradle to the mounting adaptor.

9. The support assembly of claim 8 wherein the hollow skirted portion is wider than the upwardly stepped portion for locating the skirted portion over the stepped portion, the cradle being adapted to slide over the mounting adaptor in a direction so as to cause the teeth to engage the slots.

10. The support assembly of claim 8 wherein the mounting adaptor includes catch means for abutting against a wall of the hollow skirted portion when the teeth engage the slots so as to prevent the cradle sliding over the mounting adaptor in a direction that would allow the teeth to disengage the slots.
